(19) United States
(12) Patent Application Publication
(10) Pub. No.: US 2018/0039672 A1
(43) Pub. Date: Feb. 8, 2018

(54) METHOD AND APPARATUS FOR ANSWERING QUERIES BASED ON PARTIAL AGGREGATIONS OF A CONTINUOUS DATA STREAM

(71) Applicant: AT&T Intellectual Property I, L.P., Atlanta, GA (US)

(72) Inventors: Prasad Sharanabasawa, Pleasanton, CA (US); Cary Hermann, Schaumburg, IL (US)

(21) Appl. No.: 15/228,058

(22) Filed: Aug. 4, 2016

(51) Int. Cl. G06F 17/30; H04L 29/08; H04L 29/06

(52) U.S. Cl. CPC G06F 17/30516; G06F 17/30489; H04L 65/4069; H04L 67/18; H04L 67/22

(57) ABSTRACT

A method and apparatus for answering a query based on a partial aggregation of a continuous data stream generated by a network element within a communication network are disclosed. For example, the method receives a template that contains one or more parameters for obtaining the partial aggregation of the continuous data stream, generates the query based on the template that is received, obtains the partial aggregation of the continuous data stream based on the template, provides an answer to the query based on the partial aggregation, repeats the obtaining and the providing based on a most recent partial aggregation until all data for a predefined time period is aggregated from the network element and transmits the answer to a controller to make an adjustment to the network element based on the answer.

The present disclosure relates to analyzing a continuous data stream from network elements within a communication network and, in particular, a method and apparatus for answering queries based on partial aggregations of a continuous data stream.

### BACKGROUND

Communications networks can continuously generate large amounts of data from various different network elements. However, when a user wants to analyze the continuous stream of data for a particular time period, typically, the data for the entire time period and from all of the network elements that generate the desired data is collected. The eventual amount of data that is collected and analyzed may be enormous.

Analyzing such large amounts of data can be inefficient. The analysis may be taxing on processing and memory resources within the communication network. In addition, responses to any queries may be slow or delayed due to the processing time to analyze the large amounts of data.

### SUMMARY

In one example, the present disclosure discloses a method for answering a query based on a partial aggregation of a continuous data stream generated by a network element within a communication network. For example, the method may include a processor that receives a template that contains one or more parameters for obtaining the partial aggregation of the continuous data stream, generates the query based on the template that is received, obtains the partial aggregation of the continuous data stream based on the template, provides an answer to the query based on the partial aggregation, repeats the obtaining and the providing based on a most recent partial aggregation until all data for a predefined time period is aggregated from the network element and transmits the answer to a controller to make an adjustment to the network element based on the answer.

### BRIEF DESCRIPTION OF THE DRAWINGS

The teaching of the present disclosure can be readily understood by considering the following detailed description in conjunction with the accompanying drawings, in which:

FIG. 1 illustrates an example communication network related to the present disclosure;

FIG. 2 illustrates an example of partial aggregations and cumulative aggregations of a continuous data stream;

FIG. 3 illustrates a flowchart of an example method for answering a query based on a partial aggregation of a continuous data stream generated by a network element within a communication network; and

FIG. 4 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a method and apparatus for answering a query based on a partial aggregation of a continuous data stream generated by a network element within a communication network. As discussed above, communications networks can continuously generate large amounts of data from various different network elements. However, when a user wants to analyze the continuous stream of data for a particular time period, typically, the data for the entire time period and from all of the network elements that generate the desired data is collected. The eventual amount of data that is collected and analyzed may be enormous.

Analyzing such large amounts of data can be inefficient. For example, different network elements may have different types of data collection parameters and querying the data may require querying different sets of data and then analyzing the answer to the query for each set of data. This analysis may be taxing on processing and memory resources within the communication network. In addition, responses to any queries may be slow or delayed due to the processing time to analyze the large amounts of data.

One embodiment of the present disclosure provides a method that uses predefined templates that contain one or more parameters. The one or more parameters may define parameters such as, for example, which network elements to collect data from, what type of data to collect, when to collect the data, the time intervals to collect the data, and the like. The continuous stream of data from the network elements may be collected based on the template and the data may be aggregated such that a single query may be applied to the aggregated data.

In addition, the continuous stream of data may be partially aggregated and the answer to the query may be based on the partial aggregations. As a result, the entire stream of data does not need to be collected before executing the query. Rather, the query may be applied to each partial aggregation and the answer to the query may be verified based upon a cumulative aggregation of the partial aggregations.

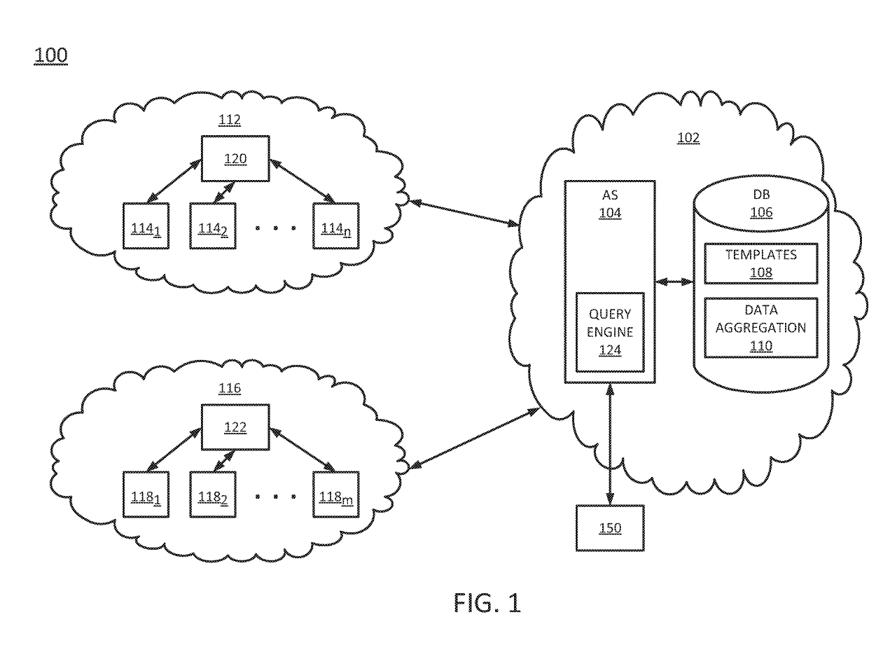

To aid in understanding the present disclosure, FIG. 1 illustrates an example communications network 100. The communications network 100 may include an Internet protocol (IP) network 102. The IP network 102 may be an IP network 102 managed and controlled by an IP service provider. The IP network 102 may include additional network elements and/or access networks not shown (e.g., border elements, gateways, routers, firewalls, switches, call control elements, cellular access networks, broadband access networks, and the like).

In one embodiment, the IP network 102 may include an application server (AS) 104 and a database (DB) 106. The AS 104 may include a processor and memory for storing instructions executed by a processor to perform the functions described herein. In one embodiment, the AS 104 may include a query engine 124. The query engine 124 may perform the queries on the partial aggregations of a continuous data stream as discussed herein.

In one embodiment, the DB 106 may store one or more templates 108 and data aggregations 110. The DB 106 may also store the data streams that are received or another DB may be deployed to store the data streams that are received. In one embodiment, the templates 108 may be stored in a table. Each row of the table may represent a different template 108. Each column may represent one or more different parameters associated with each template. In one embodiment, the template may define a type of network element to collect data from, one or more different parameters associated with the data associated network and a threshold. For example, the one or more different parameters may include what schema the data is in, which database table each data stream is from, which fields should be aggregated, one or more conditions on the data, what operations to apply to the data, and the like.

The threshold may include time thresholds or geographic thresholds. For example, the time thresholds may define the time windows for each partial aggregation, the total desired time for collecting all of the data, and the like. The geographic thresholds may define the groups of network elements the data is collected from, network elements within a particular location, and the like.

In one embodiment, the templates 108 may be predefined. The templates 108 may be added or removed from the table as the needs of the service provider change.

In one embodiment, the templates 108 may be in any query language to allow the templates 108 to be platform independent. Thus, the templates 108 may be used with any type of database. For example, the templates 108 may be a standard query language (SQL) template. In one embodiment, based on the template 108 that is selected, the query engine 124 may automatically create or generate a query. For example, the query may be an SQL query. The data may be queried, aggregated and stored in the DB 106 as the data aggregations 110.

In one embodiment, one or more network elements 114₁ to 114ₙ (hereinafter also referred to individually as network element 114 or collectively as network elements 114) may be part of a first group 112. In one embodiment, one or more network elements 118₁ to 118ₙ (hereinafter also referred to individually as network element 118 or collectively as network elements 118) may be part of a second group 116. The first group 112 and the second group 116 may different logical groups, different geographic regions, different buildings, and the like. Although only two different groups are shown for ease of explanation, it should be noted that a communications network service provider may have thousands of different groups of network elements.

In one embodiment, the continuous streams of data may be generated by the one or more network elements 114₁ to 114ₙ or the one or more network elements 118₁ to 118ₙ. The network elements 114 and 118 may be any type of network element, such as for example, a router, a switch, a gateway, a cellular tower, a border element, a server, and the like.

In one embodiment, the first group 112 of network elements 114 may be controlled by a first controller 120 and the second group 116 of network elements 116 may be controlled by a second controller 122. In one embodiment, the first controller 120 and the second controller 122 may collect data from the respective network elements 114 and 118 and forward them to the AS 104. In another embodiment, the network elements 114 and 118 may directly send the data to the AS 104.

In one embodiment, based upon a query that is executed by the query engine 124 on the data that is being transmitted from the network elements 114 and 118, the AS 104 may signal the first controller 120 or the second controller 122 to take some action in response to the result of the query. For example, the AS 104 may instruct the first controller 120 to make a modification, a configuration change, re-route data to different network elements 114, and the like based on the result of the query.

In one embodiment, the communications network 100 may include an endpoint device 150. For example, the endpoint device 150 may be a desktop computer, a laptop computer, a tablet computer, and the like and be in communication with the endpoint device 150. The endpoint device 150 may be used to allow a user to submit a request for a query for a particular KPI data from the network elements 114 and 118. In one embodiment, the endpoint device 150 may be used to select a template 108 from the DB 106. The endpoint device may also be used as a display to present the answers to the queries to the user.

As noted above, the network elements 114 and 118 may generate continuous streams of data. The continuous streams of data may be related to any type of characteristic associated with the network elements 114 and 118 or key performance indicators (KPI). For example, the continuous streams of data may include processor utilization, data throughput rates, error logs, memory usage, capacity utilization, and the like. Before, if a user of the communications network provider wanted to analyze a particular characteristic (e.g., processor utilization) the user would have had to collect all of the data from all of the desired network elements 114 and 118 within a desired time period. The amount of data that would be collected would be enormous and applying a query to the enormous amounts of data could consume large amount of resources, take a large amount of time and generally be inefficient.

However, with the present disclosure, partial aggregations may be performed on the continuous data streams using a template 108. That is, the template 108 may identify which databases the data is to be collected from, which fields of the database are to be analyzed, what schema the data is in such that data in different schema can be converted and aggregated, what operation to apply to the data, over what time intervals (e.g., every 30 minutes, every hour, every 2 hours, and the like) within the desired time period (e.g., a 24 hour period or a one week period), and the like. The partial aggregations of the continuous data stream may be time stamped and stored until all of the data for a predefined time period is analyzed and query is answered.

In addition, the partial aggregations may allow network elements 114 and 118 to report data on a best effort basis. For example, the partial aggregations are time stamped and queried incrementally. As a result, whether the network elements 114 and 118 reports data at the first time window increment or a last time window increment does not matter. Thus, instead of requiring a network elements 114 and 118 to use processing resources to transmit data when the network elements 114 and 118 are overloaded, the partial aggregations may allow the network elements 114 and 118 to report data when processing resources are available as long as the data is reported before the expiration of the desired overall time period for collecting all of the data.

Time stamping the partial aggregations of data may also ensure that the query is not applied to data that was previously analyzed. For example, the query engine 124 may query only partial aggregations of data that have not been previously queried.

In one embodiment, more than one template 108 may be selected. For example, if the data collected from the network elements 114 and 118 need to be partially aggregated in different ways, multiple templates 108 may be selected. The query engine 124 may then automatically generate a plurality of queries (e.g., one query for each one of the multiple templates 108) and multiple parallel partial aggregations may be performed on the continuous stream of data according to each one of the multiple templates 108 that was selected.

As a result, the user may immediately begin applying the query to the data stream and have an answer to the query. The answer to the query may be updated after each time interval that is analyzed. In addition, each partial aggregation may be analyzed without having to re-analyze the previous partial aggregations. In one embodiment, the final answer to the query may be verified based on an analysis of the complete aggregation of the data within the desired time period.

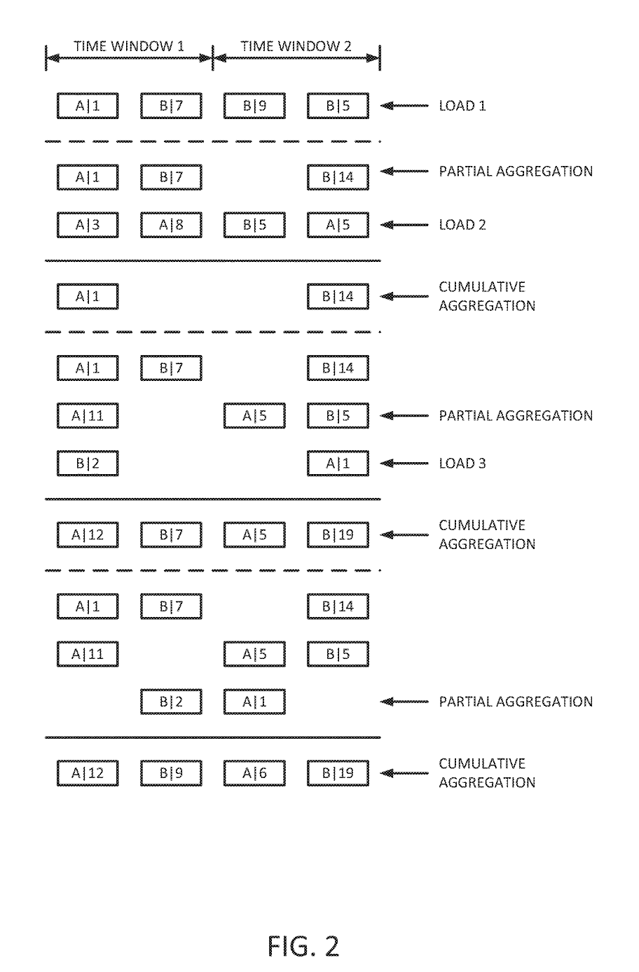

FIG. 2 illustrates an example of how partial aggregations are executed based on a template 108. It should be noted that FIG. 2 does not necessarily illustrate a particular sequence or order. Rather FIG. 2 is illustrated in a way to easily explain the concept of partial aggregations based on templates 108 described herein.

In one embodiment, the template 108 may specify to aggregate data from network element A and network element B at a particular periodic interval of time window 1 and time window 2. However, it should be noted that the partial aggregations may also be based on geography rather than a particular time window. For example, the template 108 may aggregate data from a first group of network elements and a second group of network elements.

Referring back to FIG. 2, the template 108 may add the values for the data that is collected. The query may be written by the query engine 124 to determine what a total value of a particular parameter is for both network element A and B within a total desired time period. In other words, the total desired time period may be 24 hours and the template 108 may define the time windows 1 and 2 as a same or a different time interval (e.g., 6 hour time window or a 6 hour time window and a 12 hour time window).

In one embodiment, Load 1 may collect data that was generated by network element A and network element B within time window 1 and time window 2. The first partial aggregation may sum the values from network element B that were collected in time window 2. The cumulative aggregation after the first partial aggregation may also be calculated and the query may be applied.

At a time after the Load 1, Load 2 may collect data that was generated by network element A and network element B within time window 1 and time window 2. A second partial aggregation may be applied to the Load 2 to sum the values from the network element A (e.g., 3+8 from Load 2 is summed to 11) and the order of the network elements may be aggregated (e.g., A before B). The cumulative aggregation may also be calculated from the first partial aggregation and the second partial aggregation and the query may be applied.

At a time after the Load 2, Load 3 may collect data that was generated by network element A and network element B within time window 1 and time window 2. A third partial aggregation may be applied to the Load 3 to position the data in the proper order or column. The cumulative aggregation may also be calculated from the first partial aggregation, the second partial aggregation and the third partial aggregation and the query may be applied.

In one embodiment, each Load of data may be received or obtained from a separate database. For example, the continuous stream of data may be fed to a first database and each load of data may be obtained from the first database. Each partial aggregation may be time stamped and stored in a database that is different than the database that the continuous stream of data is fed into.

As a result, the query may be applied after each partial aggregation without having to wait for the entire set of data to be received within the desired time period. In addition, each load of data was aggregated without having to re-process the previous loads of data that were received and already aggregated. Each partial aggregation can be stored and used to calculate a current cumulative aggregation that can be used for the query. In other words, the creation of the templates 108 and the partial aggregations of data based on the selected templates 108 improve the efficiency of the query engine 124 in performing queries on large continuous streams of data generated by a plurality of different network elements 114 and 118 in different regions or groups 112 and 116.

In one embodiment, based on the results of the query, the AS 104 may take some action in response to the results or answers to the query. For example, if the query determines that processing utilization is too high on the network element A, then AS 104 may reroute some of the processing to additional nearby network elements, generate a notification to the communications service provider to add more capacity in the first group 112, and the like.

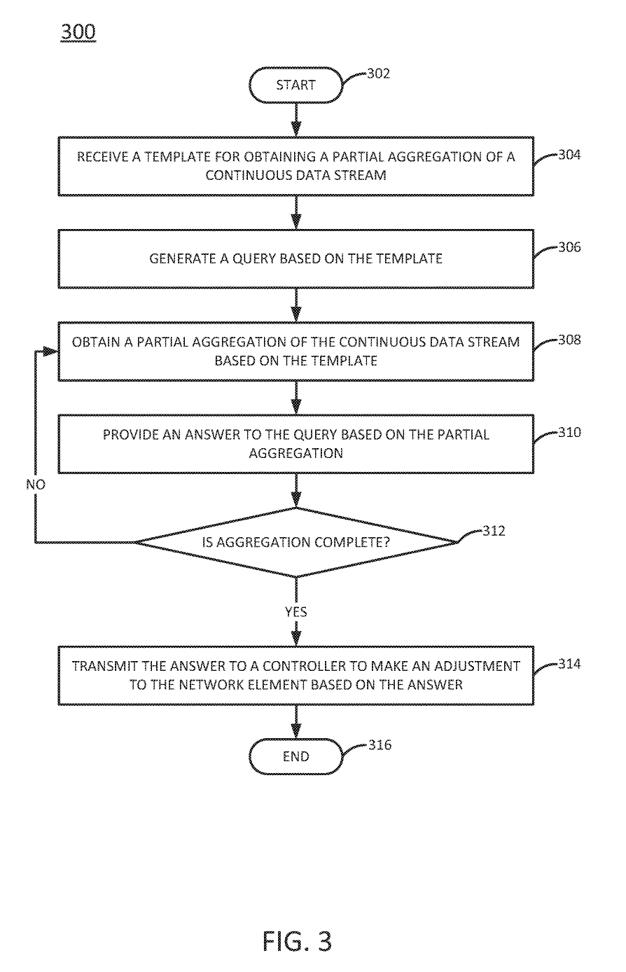

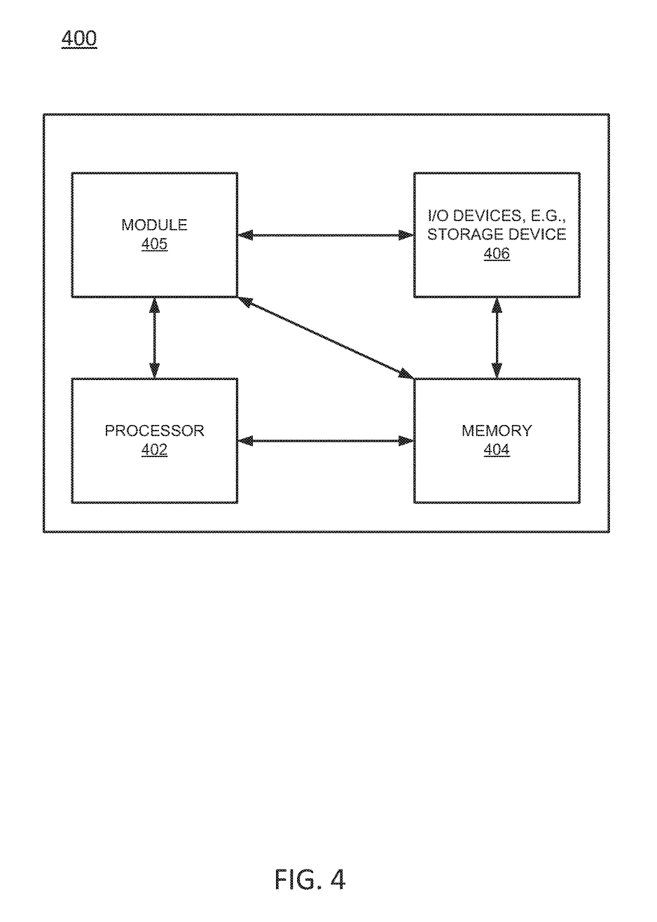

FIG. 3 illustrates a flowchart of an example method 300 for answering a query based on a partial aggregation of a continuous data stream generated by a network element within a communication network in accordance with the present disclosure. In one embodiment, steps, functions, and/or operations of the method 300 may be performed the AS 104 or the query engine 124. In one embodiment, the steps, functions, or operations of method 300 may be performed by a computing device or system 400, and/or processor 402 as described in connection with FIG. 4 below. For illustrative purpose, the example method 300 is described in greater detail below in connection with an embodiment performed by a processor, such as processor 402.

The method 300 begins in step 302. At step 304, a processor receives a template for obtaining a partial aggregation of a continuous data stream. For example, the template may be selected from a plurality of templates in a table that is stored in a database. The template may define one or more parameters that can be used to automatically generate a query. For example, the template may define a type of network element to collect data from, one or more different parameters associated with the data associated network and a threshold. For example, the one or more different parameters may include what schema the data is in, which database table each data stream is from, which fields should be aggregated, one or more conditions on the data, what operations to apply to the data, and the like.

The threshold may include time thresholds or geographic thresholds. For example, the time thresholds may define the time windows for each partial aggregation, the total desired time for collecting all of the data, and the like. The geographic thresholds may define the groups of network elements the data is collected from, network elements within a particular location, and the like.

The template may be platform independent. In other words, the template may be written in any database compatible format or language. One example, may be an SQL template.

In one embodiment, the templates may be predefined. For example, a service provider may determine various types of data that can be collected from one or more different network elements and create the appropriate template or templates. As additional types of data are desired by the service provider, or as previous types of data are no longer needed, the templates can be added or removed from the table.

At step 306, the processor generates a query based on the template. As noted above, the template may provide the parameters needed to generate a query. In one example, a query engine may automatically generate the query based on the template. In one embodiment, the query may be written in the same language as the template. For example, if the template is an SQL template, the query may be an SQL query.

At step 308, the processor obtains a partial aggregation of the continuous data stream based on the template. For example, the template may define one or more time windows to capture data from the continuous data stream. Data within the time windows defined by the selected template may be collected and aggregated. In one embodiment, the partial aggregation may be time stamped and stored separately from where the continuous data stream is stored.

At step 310, the processor provides an answer to the query based on the partial aggregation. In one embodiment, the query may be applied to the partial aggregation. In one embodiment, if previous aggregations were preformed, the current partial aggregation may be aggregated with previous partial aggregations (e.g., a cumulative aggregation) and the query may be applied. However, it should be noted that the previous aggregations do not need to be processed again.

At step 312, the processor determines if the aggregation is complete. For example, the template may define the total data collection time period to be 24 hours. Thus, after 24 hours have elapsed, the processor may determine that the aggregation is complete.

In another embodiment, the partial aggregation may be based on geography. For example, the template may define that the total data collection may be from a first group of network elements in a first location. Thus, when all of the data is received from the first group of network elements, the aggregation may be complete.

If the aggregation is not complete, then the processor may return to step 308 and repeat steps 308-310 until the aggregation is complete. In other words, the answer to the query may be continuously updated as additional data is partially aggregated and the query is repeatedly applied to the data.

If the aggregation is complete, then the processor may proceed to step 314. At step 314, the processor transmits the answer to a controller to make an adjustment to the network element based on the answer. For example, the answer to the query may determine that a particular network element is over utilized, that all of the network elements are running near full capacity, that one particular network element has an error rate above a threshold, and the like. The processor may transmit a signal to a controller to cause the controller to take action on the network element. In one embodiment, the action may include making a change to a configuration of the network element, adding a network element, removing a network element, and the like. At step 316, the method 300 ends.

It should be noted that although not specifically specified, one or more steps, functions or operations of the method 300 may include a storing, displaying and/or outputting step as required for a particular application. In other words, any data, records, fields, and/or intermediate results discussed in the respective methods can be stored, displayed and/or outputted to another device as required for a particular application. Furthermore, steps, blocks or operations in FIG. 3 that recite a determining operation or involve a decision do not necessarily require that both branches of the determining operation be practiced. In other words, one of the branches of the determining operation can be deemed as an optional step. In addition, one or more steps, blocks, functions or operations of the above described method 300 may comprise optional steps, or can be combined, separated, and/or performed in a different order from that described above, without departing from the example embodiments of the present disclosure. Furthermore, the use of the term “optional” in the above disclosure does not mean that any other steps not labeled as “optional” are not optional. As such, any claims not reciting a step that is not labeled as optional is not to be deemed as missing an essential step, but instead should be deemed as reciting an embodiment where such omitted steps are deemed to be optional in that embodiment.

FIG. 4 depicts a high-level block diagram of a computing device suitable for use in performing the functions described herein. As depicted in FIG. 4, the system 400 comprises one or more hardware processor elements 402 (e.g., a central processing unit (CPU), a microprocessor, or a multi-core processor), a memory 404 (e.g., random access memory (RAM) and/or read only memory (ROM)), a module 405 for answering a query based on a partial aggregation of a continuous data stream generated by a network element within a communication network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 300, as discussed above, is implemented in a distributed or parallel manner for a particular illustrative example, i.e., the steps of the above method 300, or the entirety of method 300 is implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 300. In one embodiment, instructions and data for the present module or process 405 for answering a query based on a partial aggregation of a continuous data stream generated by a network element within a communication network (e.g., a software program comprising computer-executable instructions) can be loaded into memory 404 and executed by hardware processor element 402 to implement the steps, functions or operations as discussed above in connection with the illustrative method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 405 for answering a query based on a partial aggregation of a continuous data stream generated by a network element within a communication network (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method for answering a query based on a partial aggregation of a continuous data stream generated by a network element within a communication network, the method comprising:
receiving, by the processor, a template that contains one or more parameters for obtaining the partial aggregation of the continuous data stream;
generating, by the processor, the query based on the template that is received;
obtaining, by the processor, the partial aggregation of the continuous data stream based on the template;
providing, by the processor, an answer to the query based on the partial aggregation;
repeating, by the processor, the obtaining and the providing based on a most recent partial aggregation until all data for a predefined time period is aggregated from the network element; and
transmitting, by the processor, the answer to a controller to make an adjustment to the network element based on the answer.

2. The method of claim 1, wherein the template is selected from a table comprising a plurality of pre-defined templates.

3. The method of claim 1, wherein the template defines a type of network element, a characteristic of the network element and a threshold.

4. The method of claim 1, wherein the query comprises a predefined query in a standard query language.

5. The method of claim 1, wherein the answer is verified based on a cumulative aggregation.

6. The method of claim 1, wherein each partial aggregation of the continuous data stream that is obtained is time stamped and stored until the all data for the predefined time period is analyzed and the answer to the query is provided.

7. The method of claim 1, wherein the partial aggregation is based on at least one of a time base or a geography base.

8. A non-transitory computer-readable storage device storing a plurality of instructions which, when executed by a processor, cause the processor to perform operations for answering a query based on a partial aggregation of a continuous data stream generated by a network element within a communication network, the operations comprising:
receiving a template that contains one or more parameters for obtaining the partial aggregation of the continuous data stream;
generating the query based on the template that is received;
obtaining the partial aggregation of the continuous data stream based on the template;
providing an answer to the query based on the partial aggregation;
repeating the obtaining and the providing based on a most recent partial aggregation until all data for a predefined time period is aggregated from the network element; and
transmitting the answer to a controller to make an adjustment to the network element based on the answer.

9. The non-transitory computer-readable storage device of claim 8, wherein the template is selected from a table comprising a plurality of pre-defined templates.

10. The non-transitory computer-readable storage device of claim 8, wherein the template defines a type of network element, a characteristic of the network element and a threshold.

11. The non-transitory computer-readable storage device of claim 8, wherein the query comprises a predefined query in a standard query language.

12. The non-transitory computer-readable storage device of claim 8, wherein the answer is verified based on a cumulative aggregation.

13. The non-transitory computer-readable storage device of claim 8, wherein each partial aggregation of the continuous data stream that is obtained is time stamped and stored until the all data for the predefined time period is analyzed and the answer to the query is provided.

14. The non-transitory computer-readable storage device of claim 8, wherein the partial aggregation is based on at least one of a time base or a geography base.

15. An apparatus for answering a query based on a partial aggregation of a continuous data stream generated by a network element within a communication network, comprising:
a processor; and
a non-transitory computer-readable storage device storing instructions, which when executed by the processor, cause the processor to perform operations, the operations comprising:
receiving a template that contains one or more parameters for obtaining the partial aggregation of the continuous data stream;
generating the query based on the template that is received;
obtaining the partial aggregation of the continuous data stream based on the template;
providing an answer to the query based on the partial aggregation;
repeating the obtaining and the providing based on a most recent partial aggregation until all data for a predefined time period is aggregated from the network element; and
transmitting the answer to a controller to make an adjustment to the network element based on the answer.

16. The apparatus of claim 15, wherein the template is selected from a table comprising a plurality of pre-defined templates.

17. The apparatus of claim 15, wherein the template defines a type of network element, a characteristic of the network element and a threshold.

18. The apparatus of claim 15, wherein the query comprises a predefined query in a standard query language.

19. The apparatus of claim 15, wherein each partial aggregation of the continuous data stream that is obtained is time stamped and stored until the all data for the predefined time period is analyzed and the answer to the query is provided.

20. The apparatus of claim 15, wherein the partial aggregation is based on at least one of a time base or a geography base.
